(19) United States
(12) Patent Application Publication
(10) Pub. No.: US 2026/0212772 A1
(43) Pub. Date: Jul. 23, 2026

(54) WORKER SUPPORT SYSTEM AND WORKER SUPPORT METHOD

(71) Applicant: TOYOTA JIDOSHA KABUSHIKI KAISHA, Toyota-shi (JP)

(72) Inventors: Tomohiro MATSUDA, Toyota-shi (JP); Tomohiro TSUBOTA, Nagoya-shi (JP); Keisuke MIURA, Toyota-shi (JP)

(73) Assignee: TOYOTA JIDOSHA KABUSHIKI KAISHA, Toyota-shi (JP)

(21) Appl. No.: 19/411,739

(22) Filed: Dec. 8, 2025

(30) Foreign Application Priority Data
Jan. 20, 2025 (JP) 2025-007682

(51) Int. Cl. G09B 5/02

(52) U.S. Cl. CPC G09B 5/02

(57) ABSTRACT

The worker support system includes: an acquisition unit configured to acquire, from a sensor worn by a worker, worker data including data related to a position of the worker and data related to a posture of the worker; an estimation unit configured to estimate the position and the posture of the worker based on the worker data; a posture determination unit configured to determine whether the posture of the worker estimated by the estimation unit matches a reference posture set in advance corresponding to the position of the worker estimated by the estimation unit; and an information output unit configured to output information indicating a determination result of the posture determination unit.

### CROSS-REFERENCE TO RELATED APPLICATION

This application claims priority to Japanese Patent Application No. 2025-007682 filed on January 20, 2025. The disclosure of the above-identified application, including the specification, drawings, and claims, is incorporated by reference herein in its entirety.

### BACKGROUND

### Technical Field

The present disclosure relates to a worker support system and a worker support method.

### Description of Related Art

For example, Japanese Unexamined Patent Application Publication No. 2018-136823 (JP 2018-136823 A) discloses a work support system configured to determine and output a degree of proficiency of a worker based on a work device closest to the worker identified from position information of the worker and a work time taken for the worker to perform work using the work device.

### SUMMARY

In JP 2018-136823 A, the position of the worker and the work time are used to determine the degree of proficiency, but the posture of the worker is not used. Therefore, there has been a problem in that the worker cannot determine whether the posture to be taken in the actual work is taken, and the worker cannot efficiently become proficient in work.

The present disclosure can be implemented as the following embodiments.

(1) According to a first embodiment of the present disclosure, there is provided a worker support system.

The worker support system includes: an acquisition unit configured to acquire, from a sensor worn by a worker, worker data including data related to a position of the worker and data related to a posture of the worker; an estimation unit configured to estimate the position and the posture of the worker based on the worker data; a posture determination unit configured to determine whether the posture of the worker that is estimated by the estimation unit matches a reference posture set in advance corresponding to the position of the worker that is estimated by the estimation unit; and an information output unit configured to output information indicating a determination result of the posture determination unit.

According to the worker support system of the embodiment, the worker can confirm whether the posture of the worker matches the reference posture by confirming the information output by the information output unit. Therefore, the worker can efficiently become proficient in the work.

(2) In the worker support system of the embodiment described above, the information output unit may be configured to output, when the posture of the worker that is estimated by the estimation unit does not match the reference posture, information for reducing a difference between the posture of the worker and the reference posture.

According to the worker support system of the embodiment, the worker can correct the posture of the worker to match the reference posture based on the information output by the information output unit. Therefore, the worker can efficiently become proficient in the work.

(3) In the worker support system of the embodiment described above, the worker support system may further include:

a generation unit configured to generate a training image in which a model worker taking the reference posture at the position that is estimated is projected into a virtual space reproducing a work environment in which the worker performs work; and a display unit worn by the worker and configured to display the training image in a field of view of the worker.

According to the worker support system of the embodiment, the worker can confirm the reference posture in the virtual space.

(4) In the worker support system of the embodiment described above,

the worker data may include time information associated with the data related to the position of the worker and the data related to the posture of the worker; the worker support system may further include a proficiency evaluation unit configured to evaluate a degree of proficiency of the worker in work based on a time taken for the worker to take the reference posture at the position that is estimated; and the information output unit may be configured to output information indicating an evaluation result of the degree of proficiency.

According to the worker support system of the embodiment, the worker can confirm the degree of proficiency in the work by confirming the information output by the information output unit.

(5) According to a second embodiment of the present disclosure, there is provided a worker support method.

The worker support method includes: acquiring, from a sensor worn by a worker, worker data including data related to a position of the worker and data related to a posture of the worker; estimating the position and the posture of the worker based on the worker data; determining whether the estimated posture of the worker matches a reference posture set in advance corresponding to the estimated position of the worker; and outputting information indicating a result of the determining.

According to the worker support method of the embodiment, the worker can confirm whether the posture of the worker matches the reference posture by confirming the information indicating the result of the determination. Therefore, the worker can efficiently become proficient in the work.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram showing a schematic configuration of a worker support system;

FIG. 2 is a flowchart of worker support processing; and

FIG. 3 is a diagram showing an example of a training image generated by a generation unit.

### DETAILED DESCRIPTION OF EMBODIMENTS

### A. First Embodiment:

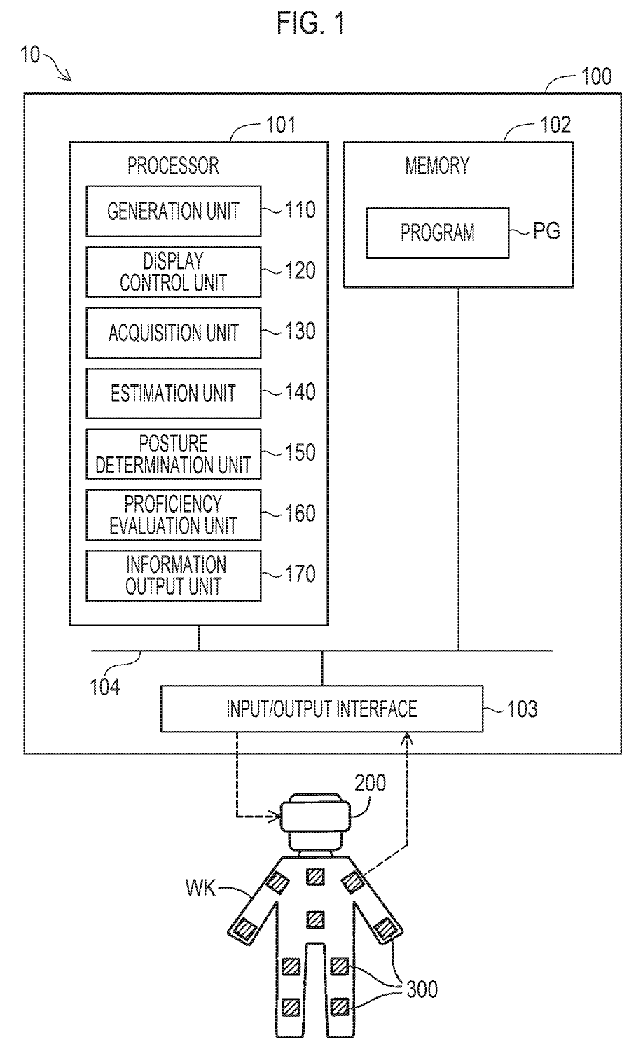

FIG. 1 is an explanatory diagram showing a schematic configuration of a worker support system 10. The worker support system 10 is a system that supports the worker WK in becoming proficient in work. The work to be performed by the worker WK is, for example, work related to the assembly of components, such as bolt tightening or connector fitting. The work to be performed by the worker WK may be work other than the assembly of the components. In the present embodiment, the worker support system 10 supports the worker WK in becoming proficient in the work by causing the worker WK to take, in a virtual space reproducing the work environment, the posture to be taken in the actual work. The worker support system 10 includes an information processing device 100 and a display device 200 worn by the worker WK.

The information processing device 100 is a computer including a processor 101, a memory 102, an input/output interface 103, and an internal bus 104. The processor 101, the memory 102, and the input/output interface 103 are connected to be bidirectionally communicable with each other via the internal bus 104. The processor 101 executes a program PG stored in the memory 102 to function as a generation unit 110, a display control unit 120, an acquisition unit 130, an estimation unit 140, a posture determination unit 150, a proficiency evaluation unit 160, and an information output unit 170. The information processing device 100 is connected to the display device 200 via wireless communication. The information processing device 100 may be connected to the display device 200 via wired communication.

The generation unit 110 generates an image of a virtual space reproducing a work environment in which the worker WK performs work. The work environment in which the worker WK performs work is, for example, a factory in which the assembly of components is performed. Hereinafter, the virtual space reproducing the work environment in which the worker WK performs work is simply referred to as a "virtual space".

The display control unit 120 displays the image generated by the generation unit 110 on the display device 200.

The acquisition unit 130 acquires, from a sensor 300 worn by the worker WK, worker data including data related to the position of the worker WK, data related to the posture of the worker WK, and time information associated with the data related to the position of the worker WK and the data related to the posture of the worker WK. The worker WK wears a position sensor for measuring the position of the worker WK and a posture sensor for measuring the posture of the worker WK, as the sensor 300. The position sensor is, for example, a beacon compliant with a Bluetooth (registered trademark) Low Energy standard. The posture sensor is, for example, an inertial sensor including an acceleration sensor and a gyro sensor. The sensor 300 described above is attached to workwear or gloves worn by the worker WK, and is connected to the information processing device 100 via wireless communication. The acquisition unit 130 acquires, for example, a signal transmitted from the beacon as the data related to the position of the worker WK. The acquisition unit 130 acquires, for example, data measured by the inertial sensor as the data related to the posture of the worker WK. The acquisition unit 130 acquires, for example, a time at which a signal transmitted from the beacon is received or a time at which the data is measured by the inertial sensor, as the time information.

The estimation unit 140 estimates the position and the posture of the worker WK based on the worker data acquired by the acquisition unit 130. The estimation unit 140 estimates, for example, an angle of each joint of the body of the worker WK or a position of each part of the body of the worker WK, as the posture of the worker WK.

The posture determination unit 150 determines whether the posture of the worker WK estimated by the estimation unit 140 matches the reference posture set in advance corresponding to the position of the worker WK estimated by the estimation unit 140. The reference posture is a posture to be taken by the worker WK in the actual work. The reference posture is stored in the memory 102 in advance. Hereinafter, a position where the reference posture is set is also referred to as a reference position. The reference position is set in advance. The reference position may be one or more. One reference posture is set in advance for one reference position.

The proficiency evaluation unit 160 evaluates the degree of proficiency of the worker WK in the work.

The information output unit 170 outputs information indicating the determination result of the posture determination unit 150. In addition, the information output unit 170 outputs information indicating an evaluation result of the proficiency evaluation unit 160.

The display device 200 is a non-see-through head-mounted display that is worn on the head of the worker WK. The display device 200 displays the image of the virtual space generated by the generation unit 110. The display device 200 is also referred to as a display unit. The display device 200 may be a see-through head-mounted display.

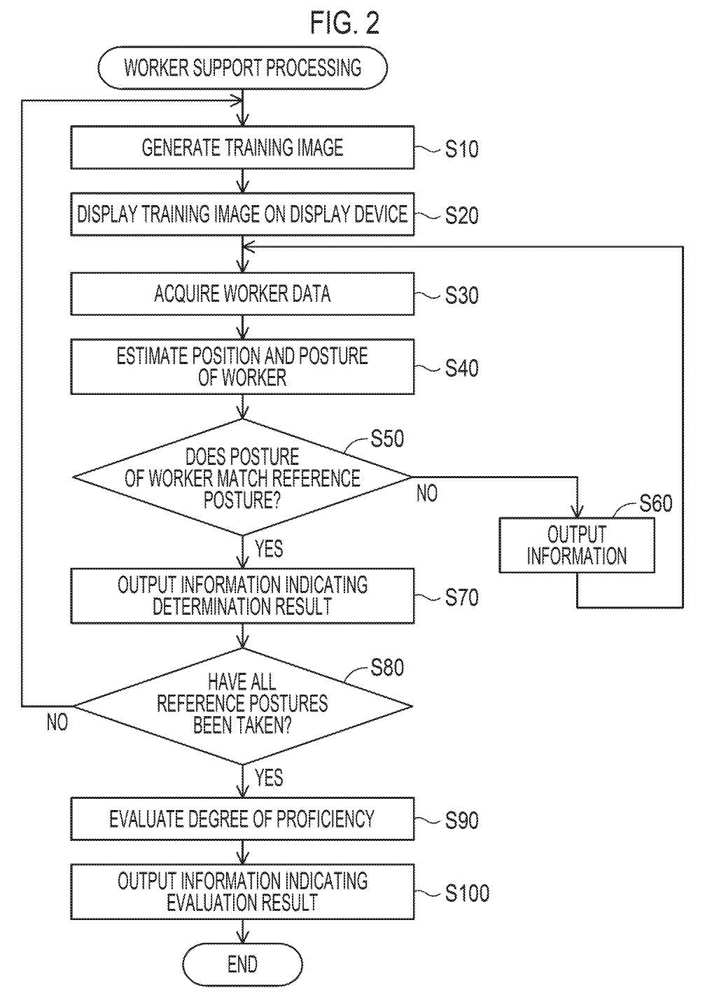

FIG. 2 is a flowchart of worker support processing for implementing the worker support method. First, in S10, the generation unit 110 generates a training image that is an image in which a model worker MW is projected into the virtual space. Here, the model worker MW is a worker taking a posture that serves as a model for the work to be performed by the worker WK. Specifically, the model worker MW is a worker taking the reference posture. The posture of the model worker MW is stored in the memory 102 in advance. The generation unit 110 generates, for example, a training image in which the model worker MW performing bolt tightening in the reference posture in a workplace where bolt tightening is performed is projected into the virtual space. The generation unit 110 may adjust the physique of the model worker MW to be close to the physique of the worker WK wearing the display device 200, and then project the model worker MW into the virtual space. In addition, the generation unit 110 may project the model worker MW into the virtual space such that the model worker MW is displayed in a semi-transparent form. In addition, a work instruction indicating the content of the work to be performed by the worker WK is displayed in the training image generated by the generation unit 110. For example, "bolt tightening" is displayed in the work instruction.

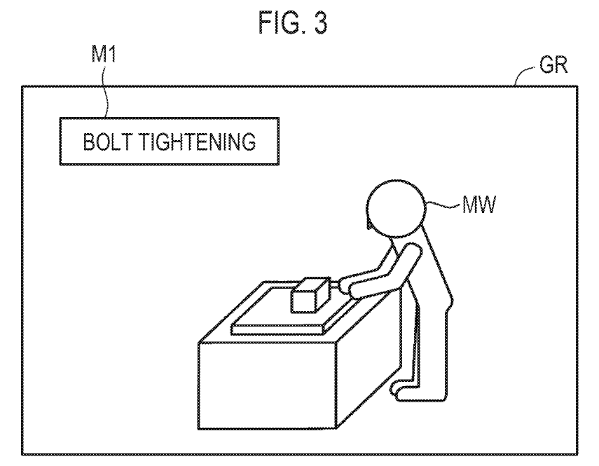

FIG. 3 is a diagram showing an example of a training image GR generated by the generation unit 110. In the training image GR shown in FIG. 3, the model worker MW performing bolt tightening in the reference posture is displayed in the virtual space. In addition, a work instruction M1 indicating "bolt tightening" is displayed in the training image GR.

In S20 of FIG. 2, the display control unit 120 displays the training image generated by the generation unit 110 on the display device 200. That is, the display device 200 displays the training image in the field of view of the worker WK. As a result, the worker WK wearing the display device 200 can see, in the virtual space, the model worker MW performing bolt tightening in the reference posture and the work instruction. The worker WK moves to the position of the model worker MW and takes the same posture as the model worker MW at the position. As a result, the worker WK can learn the position for performing bolt tightening in the actual workplace and the reference posture for the bolt tightening work.

Until the worker support processing is completed, the generation unit 110 generates the training image in real time based on the worker data, and the display control unit 120 displays the generated training image on the display device 200. As a result, the worker WK wearing the display device 200 can feel as though the worker WK is actually moving through the virtual space.

In S30, the acquisition unit 130 acquires the worker data. The worker data is stored in the memory 102.

In S40, the estimation unit 140 estimates the position and the posture of the worker WK based on the worker data acquired in S30. The position and the posture of the worker WK that are estimated are stored in the memory 102.

In S50, the posture determination unit 150 determines whether the posture of the worker WK estimated in S40 matches the reference posture set in advance corresponding to the position of the worker WK estimated in S40. The posture determination unit 150 calculates, for example, a similarity between the angle of each joint of the worker WK estimated in S40 and the angle of each joint of the model worker MW taking the reference posture. When the similarity exceeds a reference value that is predetermined, it is determined that the posture of the worker WK matches the reference posture. In a case of the reference posture in which the joint angle of a part of the body of the worker WK is emphasized, rather than the entire body of the worker WK, the posture determination unit 150 uses the similarity between the joint angle of a part of the body of the worker WK estimated in S40 and the joint angle of a part of the body of the model worker MW taking the reference posture. It may be determined whether the posture of the worker WK matches the reference posture. The reference posture in which the joint angle of a part of the body of the worker WK is emphasized is, for example, a reference posture for the work to be performed by moving solely the hand of the worker WK. In this case, a part of the body of the worker WK is the hand of the worker WK. When the posture of the worker WK estimated in S40 does not match the reference posture, S60 is executed. When the posture of the worker WK estimated in S40 matches the reference posture, S70 is executed.

In S60, the information output unit 170 outputs information for reducing a difference between the posture of the worker WK and the reference posture. In the present embodiment, the information output unit 170 provides the worker WK with information for reducing the difference between the posture of the worker WK and the reference posture. The information output unit 170 outputs, for example, a voice message from a speaker connected to the information processing device 100 or from a speaker mounted on the display device 200, the voice message indicating the direction in which to move and the angle to be taken by a part of the body of the worker WK having a large difference from the reference posture to bring the posture of the worker WK closer to the reference posture. For example, the right hand of the worker WK is at a position lower than the reference posture. In this case, the information output unit 170 outputs a voice message such as "please raise your right hand" from a speaker connected to the information processing device 100 or from a speaker mounted on the display device 200. The information output unit 170 may display, as a message on the display device 200, the direction in which to move and the angle to be taken by a part of the body of the worker WK having a large difference from the reference posture to bring the posture of the worker WK closer to the reference posture. In addition, in S60, the information output unit 170 may notify the worker WK of the determination result of the posture determination unit 150. The information output unit 170 outputs, for example, a notification sound set in advance from a speaker connected to the information processing device 100 or from a speaker mounted on the display device 200. As a result, the worker WK may be notified that the posture of the worker WK does not match the reference posture.

In S70, the information output unit 170 outputs information indicating the determination result of the posture determination unit 150. In the present embodiment, the information output unit 170 notifies the worker WK of the determination result of the posture determination unit 150. The information output unit 170 outputs, for example, a notification sound set in advance from a speaker connected to the information processing device 100 or from a speaker mounted on the display device 200. As a result, the worker WK is notified that the posture of the worker WK matches the reference posture. The notification sound output in S70 is a sound different from the notification sound output in S60.

In S80, the information processing device 100 determines whether the worker WK has taken the reference posture set in advance corresponding to each reference position at all the reference positions set in advance. When the worker WK has taken the reference posture at all the reference positions, S90 is executed. When there is a reference position where the worker WK has not taken the reference posture, the process returns to S10. When S10 is repeatedly executed, the generation unit 110 generates a training image in which the model worker MW taking the reference posture at the reference position where the worker WK has not yet taken the reference posture is projected into the virtual space. In each S10, the model worker MW is projected, in the order in which the work is performed, into the reference position where each work is performed. For example, a case where the worker WK performs connector insertion work following the bolt tightening work will be described. Here, it is supposed that the generation unit 110 has generated, in the immediately preceding execution of S10, a training image in which the model worker MW performing the bolt tightening is projected. In the next execution of S10, the generation unit 110 generates a training image in which the model worker MW performing the connector insertion in the reference posture is projected into the workplace where the connector insertion is performed. The work instruction indicating "connector insertion" is displayed in the training image generated by the generation unit 110. When there is one reference position set in advance, S80 is not executed.

In S90, the proficiency evaluation unit 160 evaluates the degree of proficiency of the worker WK in work based on a time taken for the worker WK to take the reference posture at the position estimated by the estimation unit 140. The proficiency evaluation unit 160 evaluates that the shorter the work time that is the time taken from the execution of S20 to the execution of S70 in one cycle, the higher the degree of proficiency in the work, and the longer the work time, the lower the degree of proficiency in the work. The proficiency evaluation unit 160 may evaluate the degree of proficiency of a series of work performed consecutively, rather than the degree of proficiency of each individual work. The evaluation result of the degree of proficiency is stored in the memory 102.

In S100, the information output unit 170 outputs the evaluation result of the degree of proficiency by the proficiency evaluation unit 160. In the present embodiment, the information output unit 170 notifies the worker WK of the evaluation result of the degree of proficiency by the proficiency evaluation unit 160. The information output unit 170 outputs, for example, the evaluation result of the degree of proficiency as a voice message from a speaker connected to the information processing device 100 or from a speaker mounted on the display device 200. The information output unit 170 may display the evaluation result of the degree of proficiency on the display device 200 as a message. As described above, the worker support processing is executed.

According to the first embodiment described above, the acquisition unit 130 acquires the worker data from the sensor 300 worn by the worker WK. The estimation unit 140 estimates the position and the posture of the worker WK based on the worker data. The posture determination unit 150 determines whether the posture of the worker WK that is estimated matches the reference posture set in advance corresponding to the position of the worker WK that is estimated. The information output unit 170 outputs information indicating the determination result of the posture determination unit 150. Therefore, the worker WK can confirm whether the posture of the worker WK matches the reference posture by confirming the information output by the information output unit 170. Therefore, the worker WK can efficiently become proficient in the work.

In addition, in the present embodiment, when the posture of the worker WK that is estimated does not match the reference posture, the information output unit 170 outputs information for reducing a difference between the posture of the worker WK and the reference posture. Therefore, the worker WK can correct the posture of the worker WK to match the reference posture based on the information output by the information output unit 170. Therefore, the worker WK can efficiently become proficient in the work.

In addition, in the present embodiment, the generation unit 110 generates a training image in which the model worker MW taking the reference posture at the position of the worker WK that is estimated is projected into a virtual space reproducing a work environment in which the worker WK performs work. The generated training image is displayed in the field of view of the worker WK by the display device 200 worn by the worker WK. Therefore, the worker WK can confirm the reference posture in the virtual space.

In addition, in the present embodiment, the proficiency evaluation unit 160 evaluates the degree of proficiency of the worker WK in work based on a time taken for the worker WK to take the reference posture at the position that is estimated. The information output unit 170 outputs information indicating the evaluation result of the degree of proficiency. Therefore, the worker WK can confirm the degree of proficiency in the work by confirming the information output by the information output unit 170.

### B. Other Embodiments:

### B-1

In the above-described embodiment, the information processing device 100 includes the generation unit 110 and the display control unit 120. On the other hand, the information processing device 100 may not include the generation unit 110 and the display control unit 120. That is, S10 and S20 of the worker support processing may not be executed. In this case, the worker support system 10 may not include the display device 200. In such an embodiment, the worker support system 10 supports the worker WK in becoming proficient in work by causing the worker WK to take, at the factory where the worker WK actually performs work or at a training site reproducing the factory environment, the posture to be taken in actual work.

### B-2

In the above-described embodiment, when the posture of the worker WK estimated by the estimation unit 140 does not match the reference posture, the information output unit 170 outputs information for reducing a difference between the posture of the worker WK and the reference posture. On the other hand, when the posture of the worker WK estimated by the estimation unit 140 does not match the reference posture, the information output unit 170 may not output information for reducing a difference between the posture of the worker WK and the reference posture.

### B-3

In the above-described embodiment, the information processing device 100 includes the proficiency evaluation unit 160. On the other hand, the information processing device 100 may not include the proficiency evaluation unit 160. In addition, in the embodiment, the worker data may not include time information associated with the data related to the position of the worker WK and the data related to the posture of the worker WK.

### B-4

In the above-described embodiment, the information output unit 170 notifies the worker WK of the determination result of the posture determination unit 150. In addition, when the posture of the worker WK that is estimated does not match the reference posture, the information output unit 170 provides the worker WK with information for reducing a difference between the posture of the worker WK and the reference posture. In addition, the information output unit 170 notifies the worker WK of the evaluation result of the degree of proficiency. On the other hand, the information output unit 170 may display the above-described information on a display connected to the information processing device 100, or may notify a manager of the factory where the worker WK performs the work of the above-described information.

### B-5

In the above-described embodiment, a work instruction indicating the content of the work to be performed by the worker WK is displayed in the training image generated by the generation unit 110. On the other hand, the work instruction may not be displayed in the training image generated by the generation unit 110.

### B-6

In the above-described embodiment, the information processing device 100 and the display device 200 are configured as separate devices. On the other hand, the display device 200 may have a function of the information processing device 100. In other words, the information processing device 100 and the display device 200 may be configured as an integrated device.

The present disclosure is not limited to the above-described embodiments, and can be implemented with various configurations without departing from the gist of the present disclosure. For example, the technical features in the embodiment corresponding to the technical features in each embodiment described in the section of the summary can be appropriately replaced or combined in order to solve some or all of the above-described problems. Alternatively, the technical features can be appropriately replaced or combined to achieve some or all of the above-described effects. In a case where the technical features are not described as being always needed in the present specification, the features can be deleted as appropriate.

What is claimed is:

1. A worker support system comprising:
an acquisition unit configured to acquire, from a sensor worn by a worker, worker data including data related to a position of the worker and data related to a posture of the worker;
an estimation unit configured to estimate the position and the posture of the worker based on the worker data;
a posture determination unit configured to determine whether the posture of the worker that is estimated by the estimation unit matches a reference posture set in advance corresponding to the position of the worker that is estimated by the estimation unit; and
an information output unit configured to output information indicating a determination result of the posture determination unit.

2. The worker support system according to claim 1, wherein the information output unit is configured to output, when the posture of the worker that is estimated by the estimation unit does not match the reference posture, information for reducing a difference between the posture of the worker and the reference posture.

3. The worker support system according to claim 1, further comprising:
a generation unit configured to generate a training image in which a model worker taking the reference posture at the position that is estimated is projected into a virtual space reproducing a work environment in which the worker performs work; and
a display unit worn by the worker and configured to display the training image in a field of view of the worker.

4. The worker support system according to claim 1, wherein:
the worker data includes time information associated with the data related to the position of the worker and the data related to the posture of the worker;
the worker support system further includes a proficiency evaluation unit configured to evaluate a degree of proficiency of the worker in work based on a time taken for the worker to take the reference posture at the position that is estimated; and
the information output unit is configured to output information indicating an evaluation result of the degree of proficiency.

5. A worker support method comprising:
acquiring, from a sensor worn by a worker, worker data including data related to a position of the worker and data related to a posture of the worker;
estimating the position and the posture of the worker based on the worker data;
determining whether the estimated posture of the worker matches a reference posture set in advance corresponding to the estimated position of the worker; and
outputting information indicating a result of the determining.
